(19) United States
(12) Patent Application Publication
(10) Pub. No.: US 2025/0200693 A1
(43) Pub. Date: Jun. 19, 2025

(54) GRAPHICAL RENDERING IN A MODULAR SERVER CHASSIS ENVIRONMENT

(71) Applicant: Dell Products L.P., Round Rock, TX (US)

(72) Inventors: Parminder Singh Sethi, Ludhiana (IN); Vasanth Kumar V., Bengaluru (IN); Akbar Sheriff, Salem (IN)

(21) Appl. No.: 18/544,582

(22) Filed: Dec. 19, 2023

(51) Int. Cl. G06T 1/20; G06T 3/40

(52) U.S. Cl. CPC G06T 1/20; G06T 3/40

(57) ABSTRACT

An apparatus includes at least one processing device comprising a processor coupled to a memory, wherein the at least one processing device is configured to, for a modular server environment comprising one or more modular servers with each of the one or more modular servers comprising a chassis with a plurality of modular server components installed therein, obtain images respectively associated with two or more of the modular server components, scale down the images respectively associated with the two or more modular server components, and automatically render a graphical presentation displaying the scaled down images associated with the two or more modular server components in a single view.

### FIELD

The field relates generally to information processing, and more particularly to managing information processing systems.

### BACKGROUND

A given set of electronic equipment configured to provide desired system functionality is often installed in a chassis. Such equipment can include, for example, various arrangements of storage devices, memory modules, processors, circuit boards, interface cards and power supplies used to implement at least a portion of a storage system, a multi-blade server system or other type of information processing system.

The chassis typically complies with established standards of height, width and depth to facilitate mounting of the chassis in an equipment cabinet or other type of equipment rack. Electronic equipment across multiple such chassis can function as a data center or other type of information processing system.

### SUMMARY

Illustrative embodiments provide techniques for generating and otherwise managing graphical renderings associated with electronic equipment in an information processing system such as, for example, an information processing system implemented at least in part in a modular server architecture.

In one illustrative embodiment, an apparatus includes at least one processing device comprising a processor coupled to a memory, wherein the at least one processing device is configured to, for a modular server environment comprising one or more modular servers with each of the one or more modular servers comprising a chassis with a plurality of modular server components installed therein, obtain images respectively associated with two or more of the modular server components, scale down the images respectively associated with the two or more modular server components, and automatically render a graphical presentation displaying the scaled down images associated with the two or more modular server components in a single view.

These and other illustrative embodiments include, without limitation, methods, apparatus, networks, systems and processor-readable storage media.

### BRIEF DESCRIPTION OF THE DRAWINGS

FIG. 1 shows an information processing system configured with graphical rendering logic associated with a modular server architecture in an illustrative embodiment.

FIG. 2 shows an exemplary process for graphical rendering associated with a modular server architecture in an illustrative embodiment.

FIG. 3 shows a storage architecture of a modular server in an illustrative embodiment.

FIG. 4 shows a chassis of a modular server with multiple slots in which blade and storage servers are installed in an illustrative embodiment.

FIG. 5 shows a modular server environment with a scale down image processing engine in an illustrative embodiment.

FIG. 6 shows an exemplary process for a scale down image processing engine in an illustrative embodiment.

FIG. 7 shows a modular server architecture environment with a scale down image processing engine in an illustrative embodiment.

FIG. 8 shows a graphical presentation of a management preview grid rendered by a scale down image processing engine in an illustrative embodiment.

FIGS. 9 and 10 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

Information technology (IT) assets, also referred to herein as IT equipment, may include various compute, network and storage hardware or other electronic equipment, and are typically installed in one or more electronic equipment chassis. The one or more electronic equipment chassis may form part of an equipment cabinet (e.g., a computer cabinet) or equipment rack (e.g., a computer or server rack, also referred to herein simply as a “rack”) that is installed in a data center, computer room or other facility, which can include one or more such equipment cabinets or racks. Equipment cabinets or racks provide or have physical electronic equipment chassis that can house multiple pieces of equipment, such as multiple computing devices (e.g., blade or compute servers, storage arrays or other types of storage servers, storage systems, network devices, etc.). As noted above, an electronic equipment chassis typically complies with established standards of height, width and depth to facilitate mounting of electronic equipment in an equipment cabinet or other type of equipment rack. For example, standard chassis heights such as 1U, 2U, 3U, 4U and so on are commonly used, where U denotes a unit height of 1.75 inches (1.75″) in accordance with the well-known EIA-310-D industry standard.

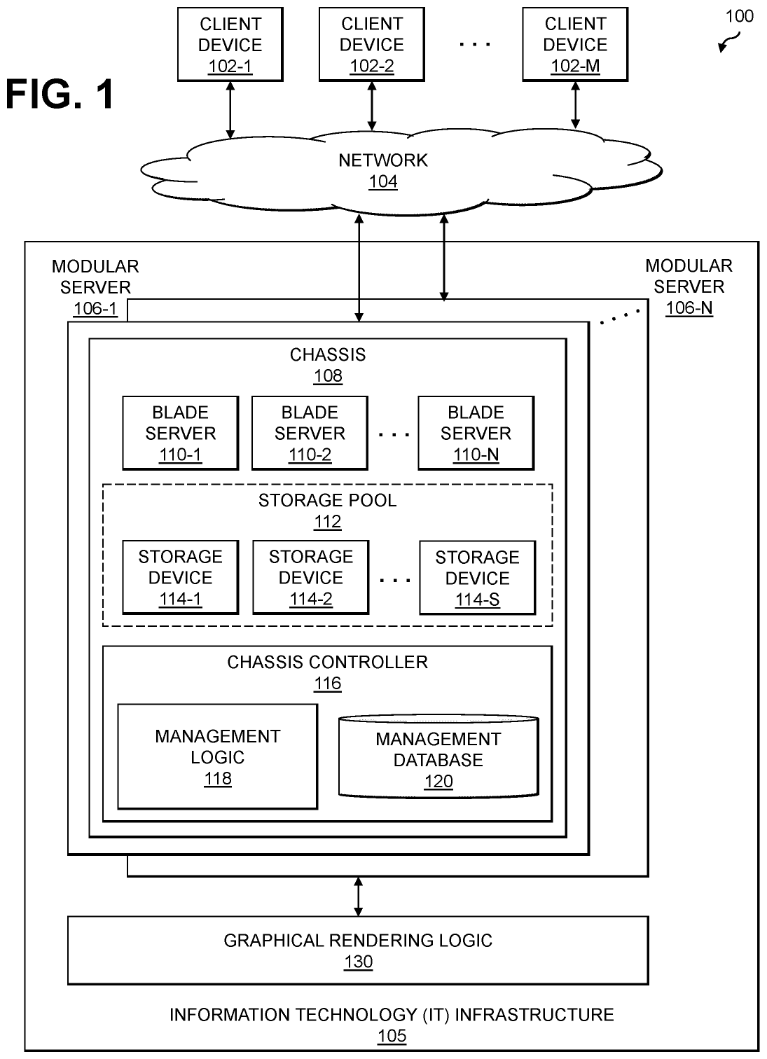

FIG. 1 shows an information processing system 100 configured in accordance with an illustrative embodiment. The information processing system 100 is assumed to be built on at least one processing platform and provides functionality for generating and otherwise managing graphical renderings associated with electronic equipment in information processing system 100. As shown, the information processing system 100 includes a set of client devices 102-1, 102-2, . . . 102-M (collectively, client devices 102, or individually, client device 102) which are coupled to a network 104. Also coupled to the network 104 is an IT infrastructure 105 comprising one or more IT assets including a set of modular servers 106-1, . . . 106-N (collectively, modular servers 106, or individually, modular server 106). The IT assets of the IT infrastructure 105 may comprise physical and/or virtual computing resources. Physical computing resources may include physical hardware such as servers, storage systems, networking equipment, Internet of Things (IoT) devices, other types of processing and computing devices including desktops, laptops, tablets, smartphones, etc. Virtual computing resources may include virtual machines (VMs), containers, etc.

Each modular server 106 includes a chassis 108 in which a set of blade servers 110-1, 110-2, . . . 110-N (collectively, blade servers 110, or individually, blade server 110) and a storage pool 112 comprising a set of storage devices 114-1, 114-2, . . . 114-S (collectively, storage devices 114 or individually, storage device 114) are installed. The chassis 108 also includes a chassis controller 116 implementing management logic 118 and a management database 120, which are configured to provide general management functionalities and storage of management data (e.g., blade server 110 to storage device 114 assignment, blade server 110 configuration, storage device 114 configuration, etc.) for the electronic equipment in the chassis 108. The management logic 118 and the management database 120 can communicate with corresponding management logic and a management database in one or more other modular servers 106 in IT infrastructure 105.

Still further, as shown and as will be further explained in detail, IT infrastructure 105 comprises graphical rendering logic 130 configured to generate and otherwise manage graphical renderings associated with the modular servers 106 in information processing system 100. In some embodiments, graphical renderings may comprise, for example, text, images, videos, and combinations thereof.

In some embodiments, the modular servers 106 are used for an enterprise system. For example, an enterprise may have various IT assets, including the modular servers 106, which it operates in the IT infrastructure 105 (e.g., for running one or more software applications or other workloads of the enterprise) and which may be accessed by users of the enterprise system via the client devices 102. As used herein, the term “enterprise system” is intended to be construed broadly to include any group of systems or other computing devices. For example, the IT assets of the IT infrastructure 105 may provide a portion of one or more enterprise systems. A given enterprise system may also or alternatively include one or more of the client devices 102. In some embodiments, an enterprise system includes one or more data centers, cloud infrastructure comprising one or more clouds, etc. A given enterprise system, such as cloud infrastructure, may host assets that are associated with multiple enterprises (e.g., two or more different businesses, organizations or other entities).

The client devices 102 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 102 may also or alternately comprise virtualized computing resources, such as VMs, containers, etc.

The client devices 102 in some embodiments comprise respective computers associated with a particular company, organization or other enterprise. Thus, the client devices 102 may be considered examples of assets of an enterprise system. In addition, at least portions of the information processing system 100 may also be referred to herein as collectively comprising one or more “enterprises.” Numerous other operating scenarios involving a wide variety of different types and arrangements of processing nodes are possible, as will be appreciated by those skilled in the art.

The network 104 is assumed to comprise a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks.

Although not explicitly shown in FIG. 1, one or more input-output devices such as keyboards, displays (video monitors) or other types of input-output devices (e.g., mouse, etc.) may be used to support one or more user interfaces to the modular servers 106, as well as to support communication between the modular servers 106 and other related systems and devices not explicitly shown.

In some embodiments, the client devices 102 are assumed to be associated with system administrators, IT managers or other authorized personnel responsible for managing the IT assets of the IT infrastructure 105, including the modular servers 106. For example, a given one of the client devices 102 may be operated by a user to access a graphical user interface (GUI) provided by the graphical rendering logic 130 to manage one or more of the blade servers 110 and/or one or more of the storage devices 114 of the storage pool 112. While shown in FIG. 1 as being externally implemented with respect to the modular servers 106 and implemented on one or more other ones of the IT assets of the IT infrastructure 105, in some embodiments, functionality of the graphical rendering logic 130 may be at least partially implemented inside the management logic 118 of the chassis controller 116, on one or more of the client devices 102, an external server or cloud-based system, etc. For example, in some embodiments, similar functionalities of the graphical rendering logic 130 are implemented in each management logic 118 of the chassis controller 116 of each modular server 106. In this manner, generation of graphical renderings across the various components of the modular servers 106 can be collectively controlled by the graphical rendering logic 130 in each of the chassis controllers 116 when the functionalities are distributed in each modular server 106. Alternatively, as mentioned and shown more generally in FIG. 1, the graphical rendering logic 130 can be implemented outside of each of the chassis controllers 116 in some embodiments.

In some embodiments, the client devices 102, the blade servers 110 and/or the storage pool 112 may implement host agents that are configured for automated transmission of information regarding the modular servers 106. It should be noted that a “host agent” as this term is generally used herein may comprise an automated entity, such as a software entity running on a processing device. Accordingly, a host agent need not be a human entity.

Each chassis controller 116 in the FIG. 1 embodiment is assumed to be implemented using at least one processing device. Each such processing device generally comprises at least one processor and an associated memory, and implements one or more functional modules or logic for controlling certain features of the modular server 106. In the FIG. 1 embodiment, the chassis controller 116 implements the management logic 118. As mentioned, data associated with management functionalities of the management logic 118 is maintained in the management database 120. In some embodiments, one or more of the storage systems utilized to implement the management database 120 comprise a scale-out all-flash content addressable storage array or other type of storage array.

Likewise, the graphical rendering logic 130 in the FIG. 1 embodiment is assumed to be implemented using at least one processing device which comprises at least one processor and an associated memory. The graphical rendering logic 130 may also have a database associated therewith (not expressly shown). In some embodiments, one or more of the storage systems utilized to implement the database associated with the graphical rendering logic 130 comprise a scale-out all-flash content addressable storage array or other type of storage array. In some embodiments wherein the graphical rendering logic 130 is implemented in the management logic 118 of each chassis controller 116, the management database 120 is used to store associated data for the graphical rendering functionalities.

The term “storage system” as used herein is therefore intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

It is to be appreciated that the particular arrangement of the client devices 102, the IT infrastructure 105 and the modular servers 106 illustrated in the FIG. 1 embodiment is presented by way of example only, and alternative arrangements can be used in other embodiments.

At least portions of the graphical rendering logic 130 may be implemented at least in part in the form of software that is stored in memory and executed by a processor.

The modular servers 106 and other portions of the information processing system 100, as will be described in further detail below, may be part of cloud infrastructure.

The modular servers 106 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The client devices 102, IT infrastructure 105, the modular servers 106 or components thereof (e.g., the blade servers 110, the storage pool 112, the chassis controller 116, the graphical rendering logic 130, etc.) may be implemented on respective distinct processing platforms, although numerous other arrangements are possible. For example, in some embodiments at least portions of the modular servers 106 and one or more of the client devices 102 are implemented on the same processing platform. A given client device (e.g., 102-1) can therefore be implemented at least in part within at least one processing platform that implements at least a portion of the modular servers 106.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the client devices 102, the IT infrastructure 105, and the modular servers 106, the graphical rendering logic 130, or portions or components thereof, to reside in different data centers. Numerous other distributed implementations are possible.

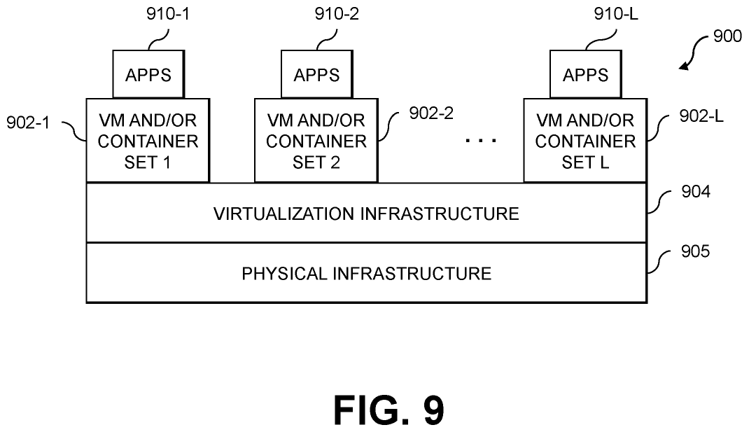

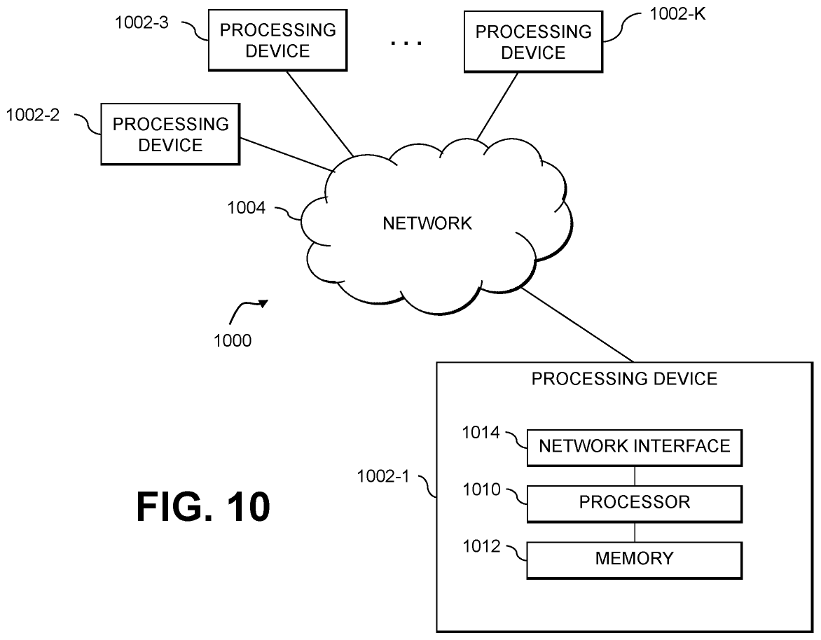

Additional examples of processing platforms utilized to implement the information processing system 100 in illustrative embodiments will be described in more detail below in conjunction with FIGS. 9 and 10.

It is to be understood that the particular set of elements shown in FIG. 1 for the graphical rendering logic 130 is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

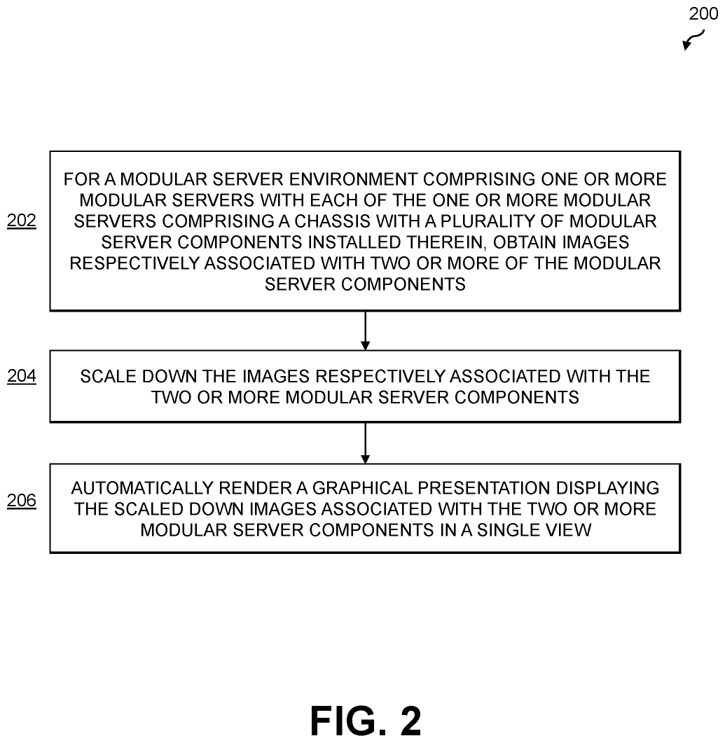

An exemplary process 200 for generating and otherwise managing graphical renderings associated with electronic equipment in an information processing system will now be described in more detail with reference to the flow diagram of FIG. 2. It is to be understood that the process 200 is an example embodiment, and that additional or alternative processes for generating and otherwise managing graphical renderings may be used in other embodiments. It is to be further understood that, in some embodiments, the process 200 is implemented at least partially by the graphical rendering logic 130 in the information processing system 100 of FIG. 1.

In this embodiment, the process 200 includes steps 202 through 206. As mentioned, in some embodiments, one or more of these steps are assumed to be performed by the graphical rendering logic 130.

The process 200 begins with step 202, for a modular server environment comprising one or more modular servers (e.g., one or more modular servers 106) with each of the one or more modular servers comprising a chassis (e.g., chassis 108) with a plurality of modular server components (e.g., blade servers 110, storage devices 114, etc.) installed therein, obtaining images respectively associated with two or more of the modular server components. Step 204 then scales down the images respectively associated with the two or more modular server components. Step 206 then automatically renders a graphical presentation displaying the scaled down images associated with the two or more modular server components in a single view.

As will be illustratively explained herein, in some embodiments, the scaled down images associated with the two or more modular server components may comprise two or more thumbnail snapshots and the automatically rendered graphical presentation may comprise a modular server component management preview grid. Further, in some embodiments, images associated with the two or more modular server components comprise respective visual status information associated with the two or more modular server components. Still further, in some embodiments, the two or more modular server components may comprise two or more servers and the respective visual status information for the two or more servers comprises respective visual operating system (OS) status for the two or more servers.

It is realized herein that due to the hardware feasibility of accommodating a large number of hard disk drives (HDDs) or other storage devices, as well as the availability of centralized storage management functionality for multiple servers, various end-users utilize a “modular” server architecture and “blade” servers for applications which require a large amount of storage space, e.g., as illustrated in FIG. 1. A modular server may include an enclosure or chassis, one or more blade servers, and one or more storage servers providing a storage pool that is utilized by the one or more blade servers. The chassis includes multiple slots in which the blade servers and storage servers may be installed. The chassis also includes management software (e.g., which may run as part of a chassis controller, chassis management console, or on a separate processing platform) providing various functionality for managing the blade servers and storage servers which are installed in the chassis. The chassis may also include one or more power supplies for powering the blade servers and storage servers installed in the chassis, cooling equipment (e.g., one or more fans) for cooling the blade servers and storage servers installed in the chassis, networking equipment (e.g., one or more network interface controllers, host adapters, etc.) which may be utilized by the blade servers and storage servers installed in the chassis, etc. In a modular server, the installed blade servers are physical servers configured to work independently, while the storage servers providing the storage pool may comprise a set of storage devices arranged in a Just a Bunch of Drives (JBOD) configuration.

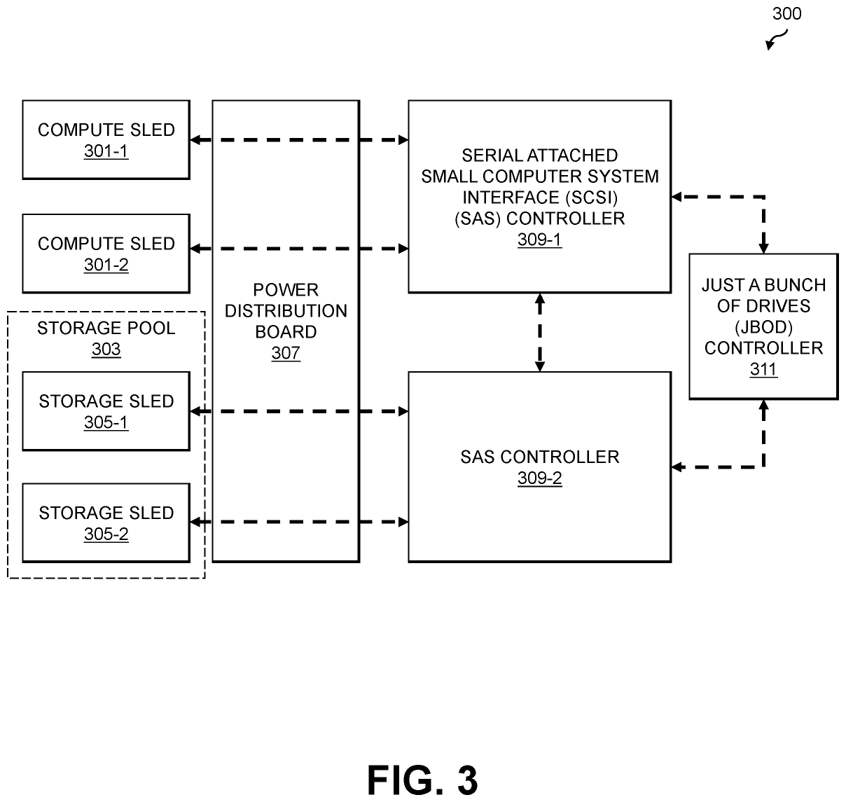

By way of example only, FIG. 3 shows a storage architecture 300 of a modular server, which includes compute sleds 301-1 and 301-2 (collectively, compute sleds 301), a storage pool 303 including storage sleds 305-1 and 305-2 (collectively, storage sleds 305), a power distribution board (PDB) 307, serial attached Small Computer System Interface (SCSI) (SAS) controllers 309-1 and 309-2 (collectively, SAS controllers 309), and a JBOD controller 311. The compute sleds 301-1 and 301-2 are each connected to each of the SAS controllers 309-1 and 309-2, via the PDB 307. Similarly, the storage sleds 305-1 and 305-2 are each connected to each of the SAS controllers 309-1 and 309-2, via the PDB 307. The SAS controllers 309-1 and 309-2 are connected to one another, as well as the JBOD controller 311. The SAS controllers 309 enable users to assign HDDs or other storage devices (e.g., of storage servers installed in the storage sleds 305 providing the storage pool 303) to different blade servers (e.g., installed in the compute sleds 301). Storage devices will be accessible to the respective blade servers to which they are assigned. The storage devices will be accessed by the particular blade servers assigned thereto through an internal storage controller (e.g., a Dell PowerEdge Redundant Array of Independent Disks (RAID) Controller (PERC) which is part of a corresponding one of the compute sleds 301).

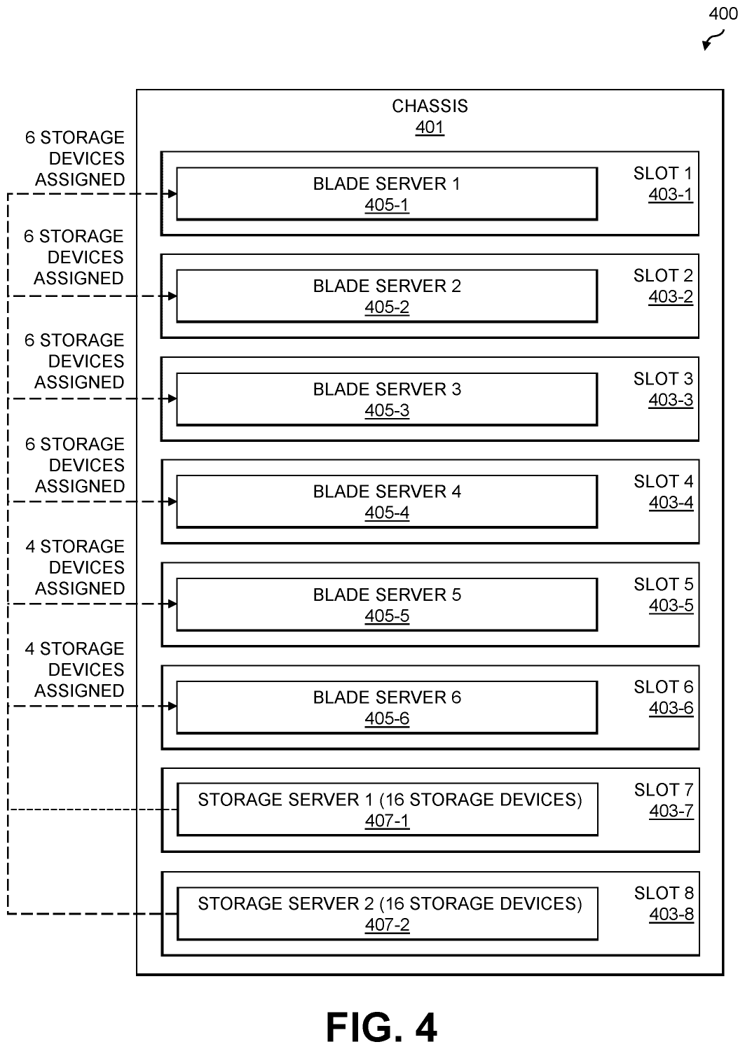

FIG. 4 shows an example of a modular server architecture 400, including a chassis 401 with a set of eight slots 403-1 through 403-8 (collectively, slots 403). A set of six blade servers 405-1 through 405-6 (collectively, blade servers 405) are installed in the slots 403-1 through 403-6 of the chassis 401, and two storage servers 407-1 and 407-2 (collectively, storage servers 407) are installed in the slots 403-7 and 403-8, respectively. The storage servers 407 may comprise Dell Insight storage pools (e.g., JBOD or other storage pools). In the FIG. 4 example, each of the storage servers 407 accommodates up to 16 HDDs or other storage devices, which are assigned to different ones of the blade servers 405 as illustrated (e.g., with six storage devices being assigned to each of the blade servers 405-1 through 405-4, and with four storage devices being assigned to the blade server 405-5 and the blade server 405-6). It should be appreciated, however, that the particular numbers of slots, blade servers, storage servers, storage devices, and the assignment of storage devices to blade servers shown in FIG. 4 is presented by way of non-limiting example only.

In the modular server architecture 400, deploying, configuring and monitoring the modular server components, e.g., blade servers 405 and storage servers 407, are critical activities that system administrators and/or other users must carry out. Tools exist to facilitate performance of these critical activities for system administrators. For example, there are interface tools that provide a secure, on-premise (e.g., when the modular server architecture 400 is located at a customer site of an enterprise that provides the modular server architecture 400), reliable option that system administrators can trust to utilize from initial power-on of the chassis 401 to troubleshooting issues during downtime/degraded performance when other remote interfaces are not working at their best. More particularly, such existing on-premise interfaces display inventory of available servers (e.g., blade servers 405 and storage servers 407). Based on user's choice, operating system (OS) video from a single server is shown on a display screen.

However, with such existing on-premise interfaces in a troubleshooting scenario, a user gets to see a textual display containing physical inventory of a chassis. The user is also allowed to see OS video only after selecting a sled (e.g., one of compute sleds 301 or storage sleds 305) or a server (e.g., one of blade servers 405 or storage servers 407), which requires intense human intervention and human intelligence to figure out the nature of the troubleshooting issue. Note that the terms compute sled and blade server (or simply, blade) are interchangeable as used herein, as are the terms storage sled and storage server or storage device. Further, the user does not have a way to see a preview of OS video for multiple servers in a sled, or multiple sleds in a chassis, in a single view (e.g., a single dashboard). Still further, such existing on-premise interfaces provide no ability to preview and render both graphics and text/console data simultaneously.

Illustrative embodiments overcome the above and other technical issues with existing interface tools by providing techniques, e.g., as disclosed above in process 200 of FIG. 2, for generating and otherwise managing graphical renderings associated with electronic equipment in an information processing system. Recall that process 200 comprises, for a modular server environment comprising one or more modular servers with each of the one or more modular servers comprising a chassis with a plurality of modular server components installed therein, obtaining images respectively associated with two or more of the modular server components. Process 200 then scales down the images respectively associated with the two or more modular server components, and then automatically renders a graphical presentation displaying the scaled down images associated with the two or more modular server components in a single view.

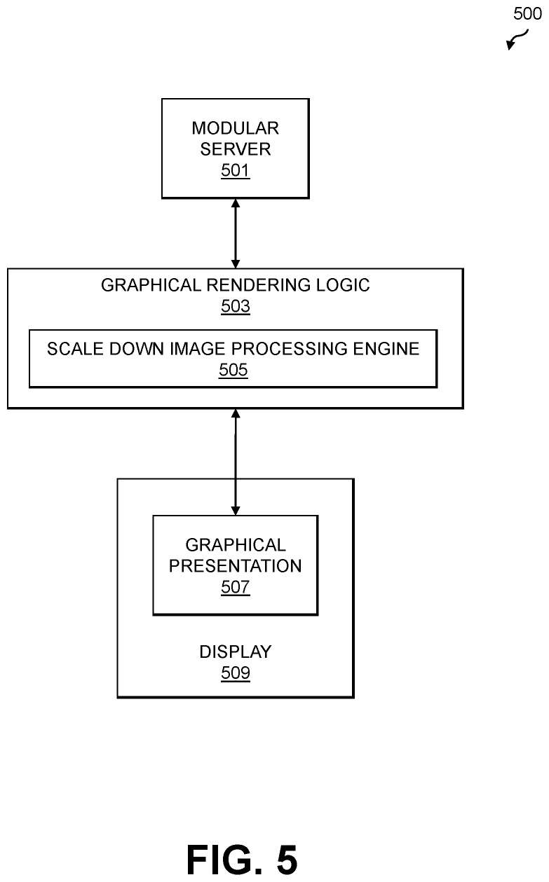

FIG. 5 shows an illustrative modular server architecture 500 with which process 200, or the like, can be performed in accordance with one or more illustrative embodiments. As shown in architecture 500, a modular server 501 is operatively coupled to graphical rendering logic 503, which comprises a scale down image processing engine 505. Graphical rendering logic 503, via scale down image processing engine 505, generates a graphical presentation 507 for display on a display 509. Note that graphical rendering logic 503, in some embodiments, corresponds to graphical rendering logic 130 depicted in the context of FIG. 1.

More particularly, scale down image processing engine 505 (abbreviated herein as SDIPE) performs or causes to be performed the steps of obtaining images respectively associated with two or more modular server components of modular server 501, scaling down the images respectively associated with the two or more modular server components, and then automatically rendering a graphical presentation 507 displaying the scaled down images associated with the two or more modular server components in a single view on display 509.

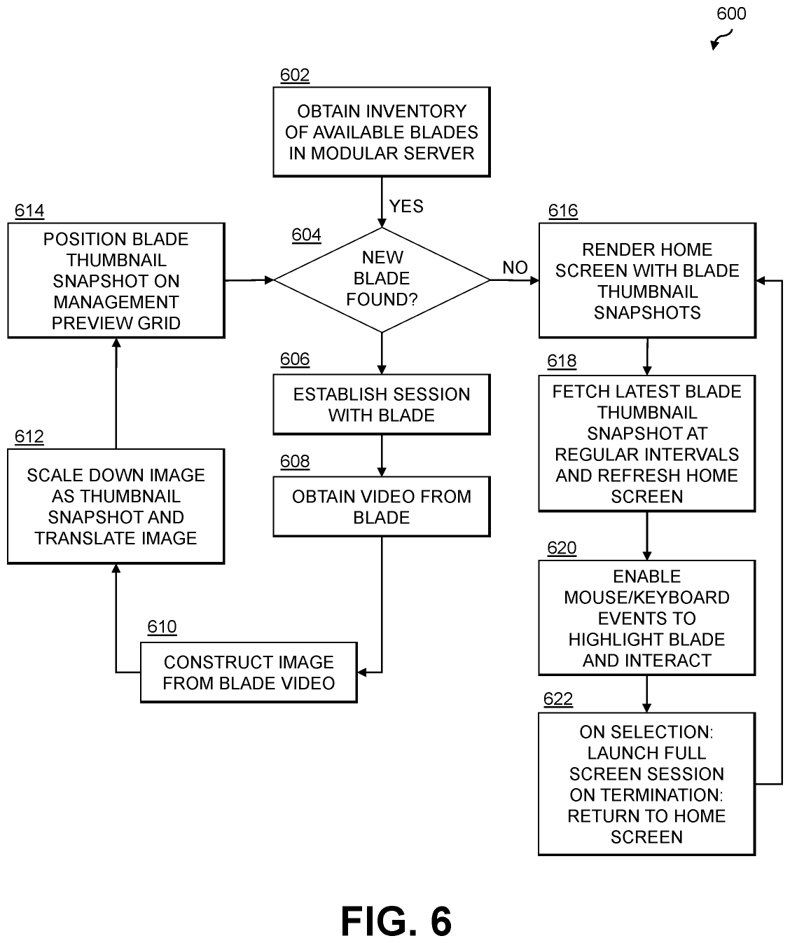

FIG. 6 illustrates a graphical rendering process 600 that can be implemented by SDIPE 505 in accordance with one or more illustrative embodiments. It is assumed that a system administrator has multiple chassis (e.g., multiple chassis 108 in FIG. 1 or multiple chassis 401 in FIG. 4) in a modular server architecture deployed at a data center (e.g., IT infrastructure 105 in FIG. 1) to perform various, customized workloads. During initial setup, hardware upgrade, repair or maintenance periods, it realized herein that it would be useful for the system administrator to be able to view a quick overview of available modular server components (e.g., blade servers, storage servers, etc.) in the modular server architecture, the current state of the operating system of each modular server component, and any health issues thereof.

The initial step in most any computational device or enterprise server is a management module booting sequence and a subsequent inventory of all the components present in the system. In a modular server architecture, or other hyperconverged system, the modular server components may include blade servers, redundant management-modules for high-availability, smart-fan controllers, AC/DC power supply units, on-premise storage servers, networking and storage input/output (I/O) modules, etc.

Graphical rendering process 600 assumes, by way of example only and for simplicity of explanation, that the modular server components are blade servers (blades). However, it is to be understood that process 600 is applicable to any one or more types of modular server components, as well as any components in general.

More particularly, as shown in FIG. 6, step 602 obtains an inventory of available blades in the modular server architecture. Step 604 then determines whether or not there is any new blade installed since a previous execution of process 600. When a new blade is detected/identified, step 606 establishes a communication session with the new blade. Step 608 obtains information from the new blade, in this case, OS video from the new blade. Step 610 then constructs an image from the OS video from the new blade. Step 612 scales down the image as a thumbnail snapshot and translates the image, and step 614 positions the blade thumbnail snapshot on a management preview grid, as will be further explained and illustrated, on a display used by a system administrator or other user (e.g., display 509).

When a new blade is not detected/identified in step 604, step 616 renders a home screen on the display with existing blade thumbnail snapshots in a management preview grid. Further, step 618 fetches the latest blade thumbnail snapshots at regular intervals (e.g., created for any new blade in step 612) and refreshes the home screen, i.e., updates the management preview grid. Step 620 enables the system administrator or other user to perform mouse/keyboard events to highlight a blade and interact therewith, e.g., hover over a thumbnail snapshot of a blade on the management preview grid and click on the thumbnail snapshot of the blade. Step 622 launches a full screen session for the selected blade to present detailed information about the blade and, upon termination by the system administrator or other user, the display returns (to step 616) to the home screen of the management preview grid.

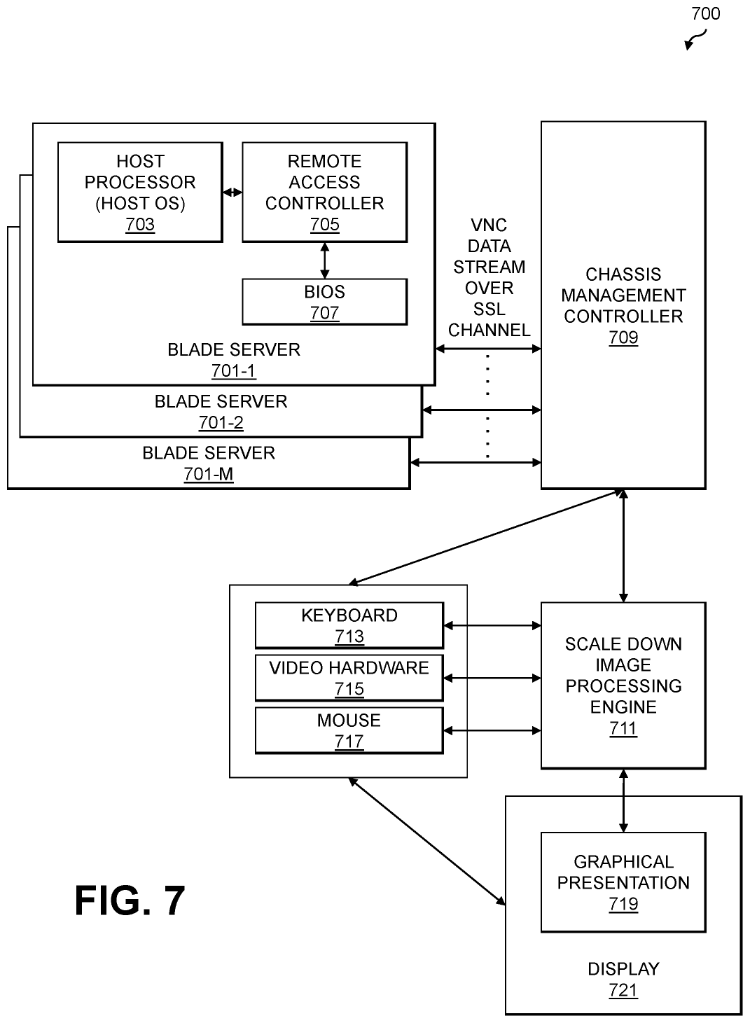

FIG. 7 illustrates a modular server architecture environment 700 in which process 600 may execute. As shown, modular server architecture environment 700 comprises a set of blade servers 701-1, 701-2, . . . , 701-M (collectively, blade servers or blades 701, or individually, blade server or blade 701). Each blade 701 comprises a host processor 703 running a host operating system (OS), a remote access controller 705, a basic input/output system (BIOS) module 707. BIOS module 707 is the program that runs when the blade 701 is powered on, and manages data flow between the blade OS and attached devices, such as, hard disks, video adapters, keyboards, mouse, printer, etc. Blades 701 are operatively coupled to a chassis management controller 709 (e.g., similar to chassis controller 116 in FIG. 1). In some embodiments, as shown, each blade 701 provides a virtual network computing (VNC) data stream over a secure socket layer (SSL) channel established with chassis management controller 709.

Further, as shown, modular server architecture environment 700 includes SDIPE 711 (i.e., SDIPE 505 running process 600) operatively coupled to chassis management controller 709. Note that, in some embodiments, SDIPE 711 can be implemented standalone or, in part or in whole, in chassis management controller 709. Further shown, a keyboard 713, video hardware 715, and a mouse 717 are operatively coupled to SDIPE 711 and a display 721. SDIPE 711 generates a graphical presentation 719 (e.g., a management preview grid with blade thumbnail snapshots) on display 721, as further explained herein.

By way of example only, assume that modular server architecture environment 700 comprises a chassis which includes a field programmable gate array (FPGA) device as part of an enclosure controller (EC) of a baseboard management controller (BMC) that is configured to provide hardware signals and notification during initial inventory as well as dynamic insertion and removal of peripherals into and out of the chassis. In some embodiments, chassis management controller 709 may be an example of an EC.

Thus, in some embodiments, SDIPE 711 and process 600 may be implemented at least in part as a part of an EC or as separate logic that communicates with the EC. If SDIPE 711 (or EC) detects a new blade for the first time (e.g., step 604 returning an affirmative (yes) result), process 600 takes additional steps to provide useful insights and actionable information to data center administrators. For example, when the inventory collection is complete, step 606 (SDIPE 711 or EC) establishes a communication session with the new blade, and obtains information in step 608, in this case, low frames per second (FPS) OS video from the new blade.

Once the presence of a new blade is identified, SDIPE 711 or the EC proceeds with discovery (identification) of connected blades 701 where instances of remote access controller 705, e.g., an Integrated Dell Remote Access Controller (iDRAC), are respectively running. Device trust and security of both the SDIPE 711 or the EC and the iDRAC are verified using authentication protocol (uses hardware identity certificates) and then a bi-directional, secure connection is established. At this stage (step 606), SDIPE 711 or EC collects data from blades 701 and collates it to provide meaningful and actionable insights to administrators.

By way of further example, a video device (display 721) is operatively connected to a chassis associated with chassis management controller 709, keyboard 713, video hardware 715, and mouse 717. Assume this connection event triggers a general-purpose input output (GPIO) interrupt in chassis management controller 709 which triggers a process running in chassis management controller 709 to probe the type of display device, and read its extended display identifier (EDID) and capabilities (e.g., supported resolutions, color depth, etc.). SDIPE 711 receives this display information, analyzes the supported capabilities, and initializes the display 721 to suitable (e.g., optimal) performance parameters.

As mentioned, a process on chassis management controller 709 establishes a secure streaming connection with each iDRAC (i.e., remote access controller 705) on each blade 701 to stream a combination of static image data and low frames-per-second (FPS) VNC video or high-quality VNC video depending on a state of SDIPE 711. SDIPE 711 performs post-processing of data received from each of the iDRACs and presents to it to display 721. Subscription and event handling methods may be integrated in SDIPE 711 to perform efficient computation of images for user presentation.

In each blade 701, the iDRAC (i.e., remote access controller 705) facilitates conversion and transmission of a host-OS video frame buffer and/or a unified extensible firmware interface (UEFI) screen over a secure SSL channel to chassis management controller 709 for subsequent scaling and transformation operations. In one example, a VNC low FPS video data is streamed from each blade 701 to enable an asynchronous thread to persistently receive and process video data in local memory (RAM). The low FPS video is converted into an image (by chassis management controller 709 or SDIPE 711) on the fly by leveraging properties of the VNC stream data and QT graphics framework application programming interfaces (APIs).

SDIPE 711 now determines that the converted image is to be scaled down (step 612) to fit the optimal resolution of the display 721. The inherent value in scaling helps in overcoming limitations of display 721 wherein display 721 may not support the resolution configured in the specific blade 701. Scaling of the image by SDIPE 711 helps overcome display resolution compatibility issues.

As a next step in post-processing of blade image data, the scaled down image is then translated (step 612) to its corresponding index or position in a screen of display 721. SDIPE 711 internal logic determines the relative position of the current blade scaled down image and positions it on the screen (step 614). In addition to video image scaling and transformation, SDIPE 711 also enables creation of a thumbnail image for QT widgets which are used to establish command-line interface connections to chassis management controller 709. With the knowledge of the current inventory (step 602), SDIPE 711 logically divides the display screen into multiple regions where each region can accommodate and display current video or a screenshot from each blade 701 in the corresponding slot. For example, a video region from blade in slot 2 of the chassis will appear after video from the blade in slot 1 and so on. SDIPE 711 built-in logic helps in reclaiming display area of blades that are not populated (or where a storage blade is present). Each of the blade OS thumbnail snapshots is then composed together in a direct framebuffer memory for quick rendering (steps 616 and 618).

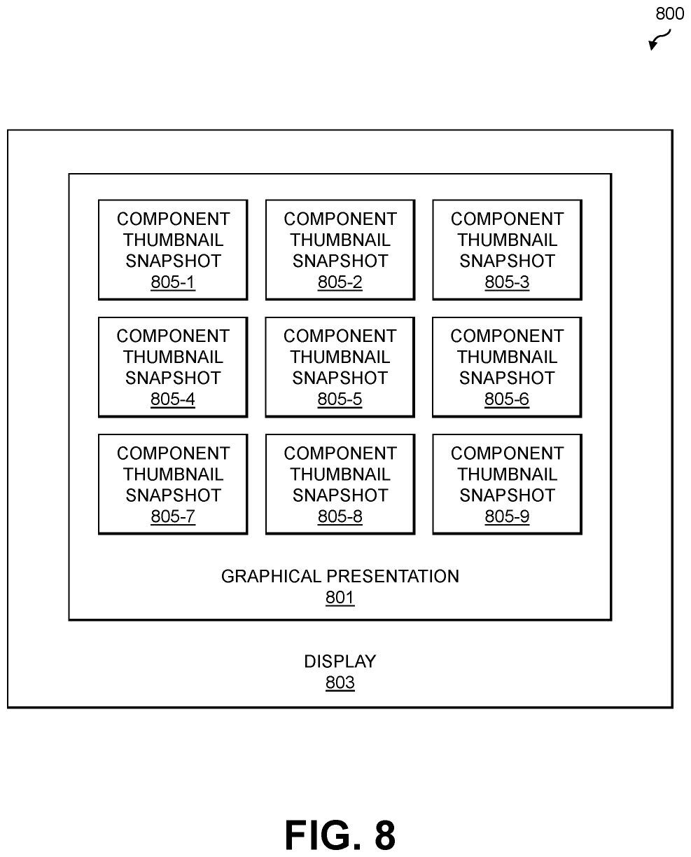

FIG. 8 illustrates a non-limiting example 800 of a graphical presentation 801 on a display 803 comprising a plurality of component thumbnail snapshots 805-1 through 805-9 (collectively, thumbnail snapshots 805, or individually, thumbnail snapshot 805) as part of a management preview screen (e.g., home screen as referenced in process 600).

For example, each one of thumbnail snapshots 805 in FIG. 8 corresponds to each one of blades 701 in FIG. 7 and its corresponding OS. As may be the case in a non-limiting example, blades 701 may be running different operating systems (to meet specific computation needs of customer workload) and some of them may be in an error state (e.g., whereby the thumbnail snapshot 805 depicts a blue screen of death (BSOD), a red screen of death (RSOD), or a yellow screen of death (YSOD)).

Each thumbnail snapshot 805 can be refreshed (step 618) by SDIPE 711, at a given refresh interval, by fetching a new image/video frame from each iDRAC and rendering it. The refresh interval can be determined based on an analysis of performance parameters so that user experience and system resource utilization are optimal. A user can interact with thumbnail snapshots 805 using keyboard 713 and/or mouse 717. The refresh rate of the thumbnail snapshot 805 on which mouse 717 is hovered can be increased to give a better user experience and highlight the blade 701 being selected. Step 622 enables a user to interact with each thumbnail snapshot 805 where a specific blade can be selected to view more details and to configure/deploy an OS or a workload in the blade or to connect to a console associated with chassis management controller 709. In some embodiments, SDIPE 711 allows a user to get back to the management preview grid comprising thumbnail snapshots 805 through a hot-key trigger.

For example, a user, e.g., a system administrator, in a typical data center that hosts different workloads across a modular server chassis will have to perform inspection, preventive maintenance, repurpose hardware or repair tasks at regular intervals. Without the advantages of an SDIPE-based solution, it would be time consuming for the user to look at the chassis inventory that is text or list based. A text/list-based inventory page does not have the ability to display status of host OS or UEFI screen, does not show any errors that popped up on the screen nor give a hint that a BSOD/RSOD/YSOD has occurred. With an SDIPE-based solution deployed, the intuitive graphic inventory screen now shows composed screen grabs from multiple blade servers in one place allowing the user to quickly view and get a summary of status and/or health of workloads running in each blade server.

Further, an SDIPE-based solution provides the visuals for the host OS of any enterprise machine without having to render (navigate) the specific server/blade by having any human intervention. The system administrator will now have the ability to view a preview of each sled host OS (or BIOS screen, etc.) without rendering the specific server on the screen. Still further, the SDIPE-based solution can intelligently and proactively convert the blade OS snapshot to the most optimal resolution by tapping into the system administrator's screen usage behavior and various configurations supported by the underlying monitor (as specified by video hardware 715) without any human intervention. As a result, blade OS data streaming will be smoothly run at any resolution which may not otherwise be supported by the monitor attached to the chassis management controller.

The SDIPE framework can check the health status of any installed sled (e.g., host OS, BIOS, etc.) and dynamically and/or proactively alert the system administration (e.g., through email/notification and other means) about the health status. This can reduce the remedy turnaround time of the issues since the detection of the issues (e.g., BSOD, RSOD, unresponsive screens, etc.) will be done proactively without any human interventions.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionalities for graphical rendering in a modular server architecture will now be described in greater detail with reference to FIGS. 9 and 10. Although described in the context of information processing system 100, these platforms may also be used to implement at least portions of other information processing systems in other embodiments.

FIG. 9 shows an example processing platform comprising cloud infrastructure 900. The cloud infrastructure 900 comprises a combination of physical and virtual processing resources that may be utilized to implement at least a portion of the information processing system 100 in FIG. 1. The cloud infrastructure 900 comprises multiple virtual machines (VMs) and/or container sets 902-1, 902-2, . . . 902-L implemented using virtualization infrastructure 904. The virtualization infrastructure 904 runs on physical infrastructure 905, and illustratively comprises one or more hypervisors and/or operating system level virtualization infrastructure. The operating system level virtualization infrastructure illustratively comprises kernel control groups of a Linux operating system or other type of operating system.

The cloud infrastructure 900 further comprises sets of applications 910-1, 910-2, . . . 910-L running on respective ones of the VMs/container sets 902-1, 902-2, . . . 902-L under the control of the virtualization infrastructure 904. The VMs/container sets 902 may comprise respective VMs, respective sets of one or more containers, or respective sets of one or more containers running in VMs.

In some implementations of the FIG. 9 embodiment, the VMs/container sets 902 comprise respective VMs implemented using virtualization infrastructure 904 that comprises at least one hypervisor. A hypervisor platform may be used to implement a hypervisor within the virtualization infrastructure 904, where the hypervisor platform has an associated virtual infrastructure management system. The underlying physical machines may comprise one or more distributed processing platforms that include one or more storage systems.

In other implementations of the FIG. 9 embodiment, the VMs/container sets 902 comprise respective containers implemented using virtualization infrastructure 904 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of information processing system 100 may each run on a computer, server, storage device or other processing platform element. A given such element may be viewed as an example of what is more generally referred to herein as a “processing device.” The cloud infrastructure 900 shown in FIG. 9 may represent at least a portion of one processing platform. Another example of such a processing platform is processing platform 1000 shown in FIG. 10.

The processing platform 1000 in this embodiment comprises a portion of information processing system 100 and includes a plurality of processing devices, denoted 1002-1, 1002-2, 1002-3, . . . 1002-K, which communicate with one another over a network 1004.

The network 1004 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1002-1 in the processing platform 1000 comprises a processor 1010 coupled to a memory 1012.

The processor 1010 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 1012 may comprise random access memory (RAM), read-only memory (ROM), flash memory or other types of memory, in any combination. The memory 1012 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1002-1 is network interface circuitry 1014, which is used to interface the processing device with the network 1004 and other system components, and may comprise conventional transceivers.

The other processing devices 1002 of the processing platform 1000 are assumed to be configured in a manner similar to that shown for processing device 1002-1 in the figure.

Again, the particular processing platform 1000 shown in the figure is presented by way of example only, and information processing system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionalities described herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, IT assets, chassis configurations, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured to:
for a modular server environment comprising one or more modular servers with each of the one or more modular servers comprising a chassis with a plurality of modular server components installed therein, obtain images respectively associated with two or more of the modular server components;
scale down the images respectively associated with the two or more modular server components; and
automatically render a graphical presentation displaying the scaled down images associated with the two or more modular server components in a single view.

2. The apparatus of claim 1, wherein the scaled down images associated with the two or more modular server components comprise two or more thumbnail snapshots and the automatically rendered graphical presentation comprises a modular server component management preview grid.

3. The apparatus of claim 1, wherein the images associated with the two or more modular server components comprise respective visual status information associated with the two or more modular server components.

4. The apparatus of claim 3, wherein the two or more modular server components comprise two or more blade servers and the respective visual status information for the two or more blade servers comprises respective visual operating system status for the two or more blade servers.

5. The apparatus of claim 3, wherein the two or more modular server components comprise two or more storage servers and the respective visual status information for the two or more storage servers comprises respective visual operating system status for the two or more blade servers.

6. The apparatus of claim 1, wherein obtaining images respectively associated with the two or more of the modular server components further comprises converting video respectively associated with the two or more modular server components to the images.

7. The apparatus of claim 1, wherein automatically rendering the graphical presentation displaying the scaled down images associated with the two or more modular server components in a single view further comprises translating the scaled down images for positioning in the single view based on one or more video capabilities associated with a display device upon which the single view is rendered.

8. The apparatus of claim 1, wherein the at least one processing device is further configured to refresh the single view based on changes to the two or more modular server components.

9. The apparatus of claim 1, wherein the at least one processing device is further configured to enable selection of any of the scaled down images to expand displayed information associated with the modular server component corresponding to the selected scaled down image.

10. A computer program product comprising a non-transitory processor-readable storage medium having stored therein program code of one or more software programs, wherein the program code when executed by at least one processing device causes the at least one processing device to:
for a modular server environment comprising one or more modular servers with each of the one or more modular servers comprising a chassis with a plurality of modular server components installed therein, obtain images respectively associated with two or more of the modular server components;
scale down the images respectively associated with the two or more modular server components; and
automatically render a graphical presentation displaying the scaled down images associated with the two or more modular server components in a single view.

11. The computer program product of claim 10, wherein the scaled down images associated with the two or more modular server components comprise two or more thumbnail snapshots and the automatically rendered graphical presentation comprises a modular server component management preview grid.

12. The computer program product of claim 10, wherein the images associated with the two or more modular server components comprise respective visual status information associated with the two or more modular server components.

13. The computer program product of claim 12, wherein the two or more modular server components comprise two or more blade servers and the respective visual status information for the two or more blade servers comprises respective visual operating system status for the two or more blade servers.

14. The computer program product of claim 12, wherein the two or more modular server components comprise two or more storage servers and the respective visual status information for the two or more storage servers comprises respective visual operating system status for the two or more blade servers.

15. The computer program product of claim 10, wherein obtaining images respectively associated with the two or more of the modular server components further comprises converting video respectively associated with the two or more modular server components to the images.

16. The computer program product of claim 10, wherein automatically rendering the graphical presentation displaying the scaled down images associated with the two or more modular server components in a single view further comprises translating the scaled down images for positioning in the single view based on one or more video capabilities associated with a display device upon which the single view is rendered.

17. The computer program product of claim 10, wherein the program code when executed by at least one processing device further causes the at least one processing device to refresh the single view based on changes to the two or more modular server components.

18. The computer program product of claim 10, wherein the program code when executed by at least one processing device further causes the at least one processing device to enable selection of any of the scaled down images to expand displayed information associated with the modular server component corresponding to the selected scaled down image.

19. A method comprising:
for a modular server environment comprising one or more modular servers with each of the one or more modular servers comprising a chassis with a plurality of modular server components installed therein, obtaining images respectively associated with two or more of the modular server components;
scaling down the images respectively associated with the two or more modular server components; and
automatically rendering a graphical presentation displaying the scaled down images associated with the two or more modular server components in a single view;
wherein the method is performed by at least one processing device comprising a processor coupled to a memory.

20. The method of claim 19, wherein automatically rendering the graphical presentation displaying the scaled down images associated with the two or more modular server components in a single view further comprises translating the scaled down images for positioning in the single view based on one or more video capabilities associated with a display device upon which the single view is rendered.
